(19) United States
(12) Patent Application Publication
(10) Pub. No.: US 2025/0005685 A1
(43) Pub. Date: Jan. 2, 2025

(54) INFORMATION PROCESSING APPARATUS, INFORMATION PROCESSING METHOD, AND NON-TRANSITORY STORAGE MEDIUM

(71) Applicant: NEC Corporation, Minato-ku, Tokyo (JP)

(72) Inventors: Keisuke IKEDA, Tokyo (JP); Masahiro TANI, Tokyo (JP); Kazufumi KOJIMA, Tokyo (JP)

(73) Assignee: NEC Corporation, Minato-ku, Tokyo (JP)

(21) Appl. No.: 18/710,772

(22) PCT Filed: Nov. 26, 2021
(86) PCT No.: PCT/JP2021/043349

§ 371 Date: May 16, 2024

(51) Int. Cl. G06Q 50/00

(52) U.S. Cl. CPC G06Q 50/01

(57) ABSTRACT

The present invention provides an information processing apparatus (1000) including: an activity area estimation unit (1001) that estimates an activity area of a user of an account of social media, based on public information being published on the Internet in association with the account; and a relationship estimation unit (1002) that estimates a relationship between a user of the account and the activity area, based on the public information.

### TECHNICAL FIELD

The present invention relates to an information processing apparatus, an information processing method, and a program.

### BACKGROUND ART

Techniques related to the present invention are disclosed in Patent Documents 1 to 4 and Non-Patent Documents 1 to 7.

Patent Document 1, Non-Patent Documents 1 to 4, and Non-Patent Document 7 disclose a technique for estimating an activity range of a user having an account on social media such as a social networking service (SNS), based on a friendship.

Patent Documents 2 to 4, Non-Patent Document 5, and Non-Patent Document 6 disclose a technique for determining an account on social media such as an SNS being possessed by the same person.

Patent Document 5 discloses a technique for determining a position of a user when text data and the like are posted on social media such as an SNS.

### RELATED DOCUMENT

### Patent Document

Patent Document 1: International Patent Publication No. WO2021/028988
Patent Document 2: International Patent Publication No. WO2019/187107
Patent Document 3: International Patent Publication No. WO2019/234827
Patent Document 4: Japanese Patent Application Publication No. 2013-122630
Patent Document 5: Japanese Patent Application Publication No. 2018-010378

### Non-Patent Document

Non-Patent Document 1: Keisuke Ikeda, Kazufumi Kojima, Masahiro Tani, “Study for estimating the location of social media users based on geographical proximity of friends”, The Institute of Electronics, Information and Communication Engineers, IEICE technical report, Vol. 119, No. 317, pp. 37-42, A12019-36, November 2019
Non-Patent Document 2: Dan Xu, Peng Cui, Wenwu Zhu, Shiqiang Yang, “Graph-based residence location inference for social media users”, IEEE Computer Society, IEEE MultiMedia, Volume 21, Issue 4, pp 76-83, October 2014
Non-Patent Document 3: Backstrom Lars, Eric Sun, Cameron Marlow, “Find me if you can: Improving geographical prediction with social and spatial proximity” Proceedings of the 19^{th} international conference on World Wide Web, 2010, pp. 61-70
Non-Patent Document 4: Liu Zhi, Yan Huang, “Closeness and structure of friends help to estimate user locations”, International Conference on Database Systems for Advanced Applications, Springer, pp. 33-48
Non-Patent Document 5: Y. Li, Y. Peng, W. Ji, Z. Zhang, and Q. Xu, “User Identification Based on Display Names Across Online Social Networks”, IEEE Access, vol. 5, pp. 17342-17353, Aug. 25, 2017
Non-Patent Document 6: X. Han, X Liang and et al. “Linking social network accounts by modeling user spatiotemporal habits”, Intelligence and Security Informatics (ISI), IEEE International Conference on, 2017
Non-Patent Document 7: Keisuke Ikeda, Kazufumi Kojima, Masahiro Tani, “Social media user's location estimation method based on Kernel Density Estimation”, The Institute of Electronics, Information and Communication Engineers, IEICE technical report, Vol. 120, No. 379, pp. 18-23, AI2020-42, February 2021

### DISCLOSURE OF THE INVENTION

### Technical Problem

As described above, an activity range of a user can be estimated based on information being published on social media such as an SNS. Then, information being published on social media such as an SNS is required to be further effectively used.

The present invention has a challenge to generate beneficial information, based on information being published on social media such as an SNS.

### Solution to Problem

The present invention provides an information processing apparatus including:
an activity area estimation unit that estimates an activity area of a user of an account of social media, based on public information being published on the Internet in association with the account; and
a relationship estimation unit that estimates a relationship between a user of the account and the activity area, based on the public information.

Further, the present invention provides an information processing method including,
executing by a computer:
an activity area estimation step of estimating an activity area of a user of an account of social media, based on public information being published on the Internet in association with the account; and
a relationship estimation step of estimating a relationship between a user of the account and the activity area, based on the public information.

Further, the present invention provides a program causing a computer to function as:
an activity area estimation unit that estimates an activity area of a user of an account of social media, based on public information being published on the Internet in association with the account; and
a relationship estimation unit that estimates a relationship between a user of the account and the activity area, based on the public information.

### Advantageous Effects of Invention

According to the present invention, beneficial information can be generated based on information being published on social media such as an SNS.

### BRIEF DESCRIPTION OF THE DRAWINGS

FIG. 1 It is a diagram illustrating one example of a hardware configuration of an information processing apparatus according to the present example embodiment.

FIG. 2 It is one example of a functional block diagram of the information processing apparatus according to the present example embodiment.

FIG. 3 It is a flowchart illustrating an operation example of processing of the information processing apparatus according to the present example embodiment.

FIG. 4 It is a configuration diagram illustrating an overview of an estimation apparatus according to the present example embodiment.

FIG. 5 It is a configuration diagram illustrating a configuration example of an activity area estimation system according to the present example embodiment.

FIG. 6 It is a flowchart illustrating an operation example of an activity area estimation apparatus according to the present example embodiment.

FIG. 7 It is a diagram illustrating a generation example of a post distribution according to the present example embodiment.

FIG. 8 It is a diagram illustrating a generation example of a post distribution according to the present example embodiment.

FIG. 9 It is a diagram illustrating a generation example of a friend distribution according to the present example embodiment.

FIG. 10 It is a diagram illustrating a generation example of an activity area distribution according to the present example embodiment.

FIG. 11 It is a diagram illustrating an output example of an activity area distribution according to the present example embodiment.

FIG. 12 It is a configuration diagram illustrating a configuration example of the activity area estimation apparatus according to the present example embodiment.

FIG. 13 It is a flowchart illustrating an operation example of the activity area estimation apparatus according to the present example embodiment.

FIG. 14 It is a configuration diagram illustrating a configuration example of the activity area estimation apparatus according to the present example embodiment.

FIG. 15 It is a flowchart illustrating an operation example of the activity area estimation apparatus according to the present example embodiment.

FIG. 16 It is a configuration diagram illustrating a configuration example of the activity area estimation apparatus according to the present example embodiment.

FIG. 17 It is a flowchart illustrating an operation example of the activity area estimation apparatus according to the present example embodiment.

FIG. 18 It is a flowchart illustrating an operation example of processing of the information processing apparatus according to the present example embodiment.

### DESCRIPTION OF EMBODIMENTS

Hereinafter, example embodiments of the present invention will be described with reference to the drawings. Note that, in all of the drawings, a similar component has a similar reference sign, and description thereof will be appropriately omitted.

### First Example Embodiment

### Overview

An information processing apparatus according to the present example embodiment estimates an activity area of a user of an account of social media such as an SNS, based on public information being published on the Internet in association with the account. Further, the information processing apparatus estimates a relationship between the user of the account and the estimated activity area, based on the public information. In this way, the information processing apparatus according to the present example embodiment can estimate not only an activity area of a user of an account but also a relationship between the activity area and the user of the account, based on public information on social media.

### “Hardware Configuration”

Next, one example of a hardware configuration of the information processing apparatus will be described. Each functional unit of the information processing apparatus is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program previously stored at a stage of shipping of an apparatus) such as a hard disk that stores the program, and a network connection interface. Then, various modification examples of an achievement method and an apparatus thereof are understood by a person skilled in the art.

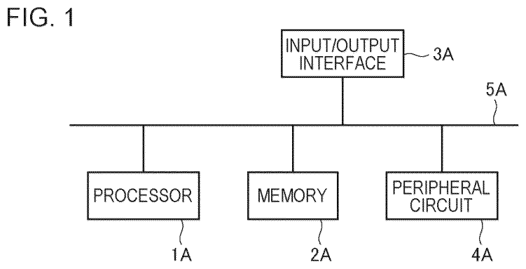

FIG. 1 is a block diagram illustrating a hardware configuration of the information processing apparatus. As illustrated in FIG. 1, the information processing apparatus includes a processor TA, a memory 2A, an input/output interface 3A, a peripheral circuit 4A, and a bus 5A. Various modules are included in the peripheral circuit 4A. The information processing apparatus may not include the peripheral circuit 4A. Note that the information processing apparatus may be formed of a plurality of apparatuses being separated physically and/or logically. In this case, each of the plurality of apparatuses can include the hardware configuration described above.

The bus 5A is a data transmission path for the processor TA, the memory 2A, the peripheral circuit 4A, and the input/output interface 3A to transmit and receive data to and from one another. The processor TA is an arithmetic processing apparatus such as a CPU and a graphics processing unit (GPU), for example. The memory 2A is a memory such as a random access memory (RAM) and a read only memory (ROM), for example. The input/output interface 3A includes an interface for acquiring information from an input apparatus, an external apparatus, an external server, an external sensor, a camera, and the like, an interface for outputting information to an output apparatus, an external apparatus, an external server, and the like, and the like. The input apparatus is, for example, a keyboard, a mouse, a microphone, a physical button, a touch panel, and the like. The output apparatus is, for example, a display, a speaker, a printer, a mailer, and the like. The processor TA can output an instruction to each of modules, and perform an arithmetic operation, based on an arithmetic result of the modules.

### “Functional Configuration”

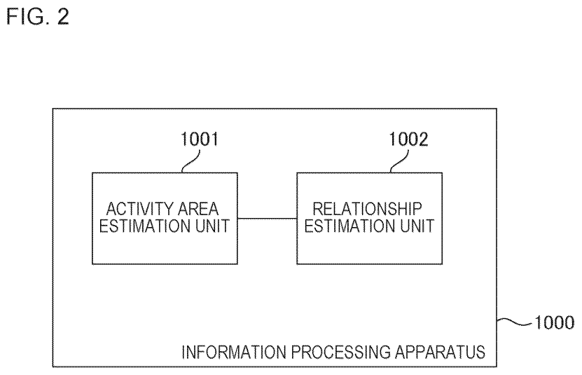

Next, a functional configuration of the information processing apparatus will be described. FIG. 2 illustrates one example of a functional block diagram of an information processing apparatus 1000. As illustrated, the information processing apparatus 1000 includes an activity area estimation unit 1001 and a relationship estimation unit 1002.

The activity area estimation unit 1001 estimates an activity area of a user of an account of social media such as an SNS, based on public information being published on the Internet in association with the account.

The “public information” can include various pieces of information being published in association with a user of each account on social media. For example, the public information includes at least one of a profile of a user of each account, a post material being posted by a user of each account, relationship information indicating a relationship with a user of another account on social media, a profile of a user of another account having a predetermined relationship with a user of each account on social media, and a post material being posted by the user of the another account.

An item included in the “profile” may vary for each of social media, and may include, for example, a username, a nickname, gender, a date of birth, nationality, age (or age group), a birthplace, a current residence, belonging (company name, school name), an alma mater, and the like.

The “post material” is a message, a still image, a moving image, a voice, and the like.

The “relationship information” is information indicating a connection with a user of another account on social media. For example, the relationship information may indicate at least one of a user of another account having a relationship such as mutual follows with a user of each account, a user of another account followed by a user of each account, a user of another account following a user of each account, a user of another account having a history of exchanging messages with a user of each account, and a user of another account that has been at the same place at the same timing as a user of each account.

“Having a history of exchanging messages” may be a state where at least one of users sends text data, a pictorial symbol, a picture, a video, a voice, an icon, and the like to the other user, and takes action by pressing a “like” button. In addition, “having a history of exchanging messages” may be a state where both users send text data, a pictorial symbol, a picture, a video, a voice, an icon, and the like to each other, and take action by pressing a “like” button.

A “user of another account that has been at the same place at the same timing as a user of each account” may be determined based on, for example, a post place and a post date and time. When a difference in post date and time falls within a reference value, and a post place is the same or the difference falls within a reference value in posts of a user of a certain account and a user of another account, the two users may be determined to have been at the same place at the same timing. In addition, when a position of a user of each account is tracked by a global positioning system (GPS), two users whose distance therebetween falls within a threshold value or two users whose distance therebetween continues to fall within a threshold value for a predetermined period of time or longer may be determined to have been at the same place at the same timing. In addition, when a facility (such as a store) used by each user and a used date and time can be acquired, two users who used the same facility and in which a difference in the used date and time falls within a reference value may be determined to have been at the same place at the same timing. A facility (such as a store) used by each user and a used date and time may be determined based on a post material of each user, or may be determined by another technique.

A “user of another account having a predetermined relationship with a user of each account” is, for example, at least one of a user of another account having a relationship such as mutual follows with a user of each account, a user of another account followed by a user of each account, a user of another account following a user of each account, a user of another account having a history of exchanging messages with a user of each account, and a user of another account that has been at the same place at the same timing as a user of each account.

The “activity area” is an area where a user of an account is active in a real world, and is indicated by municipalities, a larger area, or a smaller area.

The activity area estimation unit 1001 acquires the public information described above from a server that provides a service of social media. Then, the activity area estimation unit 1001 estimates an activity area of a user of each account, based on the acquired public information. A way of estimating an activity area of a user of each account is not particularly limited, and, for example, every technique such as the techniques disclosed in Patent Document 1, Non-Patent Documents 1 to 4, and Non-Patent Document 7 can be adopted. Further, in the example embodiments below, another example of a way of estimating an activity area of a user of each account will be described.

Note that, the activity area estimation unit 1001 may determine a plurality of accounts possessed by the same user. Then, in estimation of an activity area of a user of a certain account, not only public information being published in association with the account but also public information being published in association with another account of the user may be further used. Estimation accuracy of an activity area improves by using more pieces of public information. A way of determining a plurality of accounts possessed by the same user is not particularly limited, and, for example, every technique such as the techniques disclosed in Patent Documents 2 to 4, Non-Patent Document 5, and Non-Patent Document 6 can be adopted.

The relationship estimation unit 1002 estimates a relationship (hereinafter may be referred to as a “user-activity area relationship”) between a user of an account and an estimated activity area of the user of the account, based on the public information.

The “user-activity area relationship” can be estimated from the public information, and indicates a relationship between a user of an account and an activity area of the user. The user-activity area relationship may indicate, for example, a time relationship (i.e., which period of time is related), may indicate what meaning an activity area has for a user of an account (for example: a birthplace, a current residence, and the like), or may indicate another content. In the example embodiments below, a specific example of the user-activity area relationship will be described.

Note that, an activity area of a user of an account may be able to be handled by being divided into a plurality of sub-areas, based on a geographical relationship. For example, when an activity area includes a plurality of areas that can be discriminated from each other such as A city and B city, the activity area can be handled by being divided into a plurality of sub-areas. Further, when an activity area includes a plurality of areas away from each other, a group of areas can be handled as one sub-area.

In this way, when an activity area of a user of an account can be handled by being divided into a plurality of sub-areas, the relationship estimation unit 1002 can estimate a relationship (user-activity area relationship) with the user of the account of each sub-area.

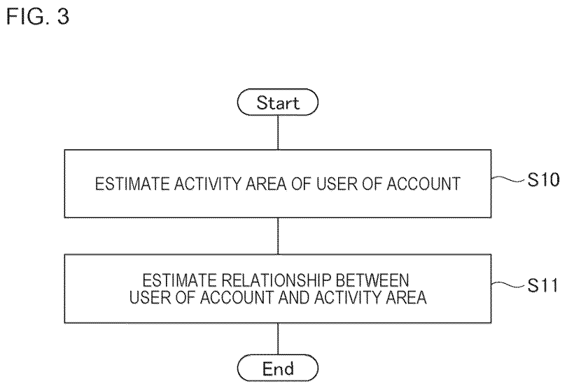

Next, one example of a flow of processing of the information processing apparatus 1000 will be described by using a flowchart in FIG. 3.

First, the information processing apparatus 1000 estimates an activity area of a user of an account of social media, based on public information being published on the Internet in association with the account (S10). Subsequently, the information processing apparatus 1000 estimates a relationship (user-activity area relationship) between the user of the account and the activity area estimated in S10, based on the public information (S11).

The information processing apparatus 1000 may register the estimated activity area and the user-activity area relationship in association with the user of the account in a storage apparatus. Further, the information processing apparatus 1000 may output information in which the estimated activity area and the user-activity area relationship are associated with the user of the account via an output apparatus. As the output apparatus, a display, a projection apparatus, a printer, a mailer, and the like are exemplified, which are not limited thereto.

### Advantageous Effect

The information processing apparatus 1000 according to the present example embodiment can estimate not only an activity area of a user of an account but also a relationship (user-activity area relationship) between the activity area and the user of the account, based on public information on social media. The information processing apparatus 1000 can generate such beneficial information, based on the public information.

### Second Example Embodiment

An information processing apparatus 1000 according to the present example embodiment estimates a period of time (user-activity area relationship) in which a user of an account is active in an activity area. Details will be described below.

A relationship estimation unit 1002 estimates a post place of a post material, i.e., a position of a user of an account when the user posts a post material. Then, the relationship estimation unit 1002 estimates a period of time in which the user of the account is active in an activity area, based on a post date and time of the post material in which the post place is included in the activity area.

Estimation of a post place can be achieved by using every technique. For example, when metadata (such as a geotag) indicating a post place are provided to a post material, the relationship estimation unit 1002 can estimate a position indicated by the metadata as the post place. In addition, the relationship estimation unit 1002 may determine a capturing position, based on a landmark captured in an image (including a still image and a moving image) being a post material, and estimate the determined capturing position as a post place. In addition, the relationship estimation unit 1002 may determine a position in which a voice is recorded, based on a background sound of voice data being a post material, and estimate the determined position as a post place. In addition, the relationship estimation unit 1002 may estimate, as a post place, a position indicated by a key word included in text data, voice data, or an image being a post material. As the key word, a place name, a name of a landmark, and the like are exemplified, which are not limited thereto. in addition, the relationship estimation unit 1002 may use the other technique as disclosed in Patent Document 5.

Next, processing of estimating a period of time in which a user of an account is active in an activity area, based on a post date and time of a post material in which a post place is included in the activity area, will be described.

First, the relationship estimation unit 1002 determines a post material in which a post place is included in an activity area. Then, the relationship estimation unit 1002 estimates a period of time in which a user of an account is active in the activity area, based on a post date and time of the determined post material.

For example, the relationship estimation unit 1002 may estimate, as a period of time in which a user of an account is active in an activity area, a period from a post date and time of a post material being first posted among determined post materials to a post date and time of a post material being last posted.

In addition, the relationship estimation unit 1002 may first remove, from among post materials in which a post place is included in an activity area, deviation data (post material) whose post date and time greatly deviates from another post material. Then, after the relationship estimation unit 1002 removes the deviation data from among the post materials in which the post place is included in the activity area, the relationship estimation unit 1002 may estimate, as a period of time in which a user of an account is active in the activity area, a period from a post date and time of a post material being first posted among the remaining post materials to a post date and time of a post material being last posted. Detection of deviation data can be achieved by using every conventional technique.

In addition, the relationship estimation unit 1002 may estimate, as a period of time in which a user of an account is active in an activity area, a period acquired by extending the period estimated as described above forward and backward by a predetermined length. As the predetermined length, “X day”, “Y month”, “Z % of a length of an estimated period of time”, and the like are exemplified, which are not limited thereto.

Another configuration of the information processing apparatus 1000 according to the present example embodiment is similar to that in the first example embodiment.

The information processing apparatus 1000 according to the present example embodiment can achieve an advantageous effect similar to that in the first example embodiment. Further, the information processing apparatus 1000 according to the present example embodiment can estimate not only an activity area of a user of an account but also a period of time in which the user of the account is active in the activity area, based on public information on social media. The information processing apparatus 1000 can generate such beneficial information, based on the public information.

### Third Example Embodiment

An information processing apparatus 1000 according to the present example embodiment estimates what meaning an activity area has for a user of an account (user-activity area relationship). Details will be described below.

A language used by a user of an account can be classified according to a language kind (such as Japanese and English). Further, one language kind can also be classified into a plurality of language kinds according to a dialect. The information processing apparatus 1000 estimates what meaning an activity area has for a user of an account, based on a relationship between a language used by the user of the account and a language generally used in the activity area.

Specifically, a relationship estimation unit 1002 compares a feature of a language used by a user of an account and a feature of a language generally used in an activity area. Then, the relationship estimation unit 1002 estimates whether the activity area is a birthplace of the user of the account, based on a comparison result. When the feature of the language used by the user of the account and the feature of the language generally used in the activity area coincide with each other, the relationship estimation unit 1002 estimates that the activity area is the birthplace of the user of the account. On the other hand, when the feature of the language used by the user of the account and the feature of the language generally used in the activity area do not coincide with each other, the relationship estimation unit 1002 estimates that the activity area is not the birthplace of the user of the account. The information processing apparatus 1000 can store, in advance, information indicating a feature of a language generally used in each region, and perform the processing described above by using the information. A language used by a user of an account is a language used in a profile and a post material.

Note that, when a user of an account uses a plurality of kinds of languages (such as Japanese and English), the relationship estimation unit 1002 may decide one of the languages as a language used by the user of the account, based on a use frequency, a degree of mastery of the language, and the like, and perform the estimation described above, based on a comparison result between a feature of the one decided language and a feature of a language used in an activity area.

For example, the relationship estimation unit 1002 may decide a language having a greatest use frequency as a language used by a user of an account. In addition, the relationship estimation unit 1002 may decide a language having a highest degree of mastery of the language as a language used by a user of an account. Evaluation of a degree of mastery of a language can be achieved by using every technique. For example, evaluation can be performed based on various items such as a degree of a grammatical mistake, a degree of errors and omissions, and a degree of difficulty of a used word. Fewer grammatical mistakes, fewer errors and omissions, and use of a word having a higher degree of difficulty increase a degree of mastery.

Another configuration of the information processing apparatus 1000 according to the present example embodiment is similar to that in the first and second example embodiments.

The information processing apparatus 1000 according to the present example embodiment can achieve an advantageous effect similar to that in the first and second example embodiments. Further, the information processing apparatus 1000 according to the present example embodiment can estimate not only an activity area of a user of an account but also whether each activity area is a birthplace, based on public information on social media. The information processing apparatus 1000 can generate such beneficial information, based on the public information.

When a birthplace is not included in a profile (public information) of a user of an account, the information processing apparatus 1000 according to the present example embodiment is beneficial. Further, even when a birthplace is included in a profile (public information) of a user of an account, there is a possibility that the user of the account may have registered a false birthplace. In consideration of such a point, also when a birthplace is included in a profile (public information) of a user of an account, the information processing apparatus 1000 according to the present example embodiment is beneficial.

### Fourth Example Embodiment

An information processing apparatus 1000 according to the present example embodiment estimates what meaning an activity area has for a user of an account (user-activity area relationship), based on public information about a user of another account having a predetermined relationship with the user of the account. Details will be described below.

A relationship estimation unit 1002 estimates a relationship (user-activity area relationship) between a user of an account and an activity area, based on public information being published on the Internet in association with a user of another account having a predetermined relationship with the user of the account.

Specifically, the relationship estimation unit 1002 estimates, as a birthplace of a user of an account, an activity area that coincides with a birthplace of a user of another account having a predetermined relationship with the user of the account. In this case, the relationship estimation unit 1002 may estimate, as the birthplace of the user of the account, an activity area coinciding with a birthplace of a user who satisfies a predetermined condition among users of other accounts having a predetermined relationship with the user of the account.

The predetermined condition is a “friend from a childhood or at a time of an elementary school student, a junior high school student, or a high school student”. Determination of whether a user of another account having a predetermined relationship with a user of an account satisfies the predetermined condition can be determined based on public information.

For example, determination may be performed based on a timing of having a predetermined relationship (such as mutual follows, following, and presence of a history of exchanging messages) on social media. A user of another account having the predetermined relationship with a user of an account in a childhood or at a time of an elementary school student, a junior high school student, or a high school student is determined to be a “friend from a childhood or at a time of an elementary school student, a junior high school student, or a high school student”.

In addition, when a user of an account calls a user of another account a “childhood friend”, a “friend at a time of an elementary school student”, a “friend at a time of a junior high school student”, a “friend at a time of a high school student”, or the like in public information or, conversely, when the user of the another account calls the user of the account by such a name in public information, the user of the another account may be determined to be a “friend from a childhood or at a time of an elementary school student, a junior high school student, or a high school student”. Note that, the names exemplified herein are merely one example. By defining, in advance, every name indicating a “friend from a childhood or at a time of an elementary school student, a junior high school student, or a high school student” and detecting use of such a name, omission in detection can be reduced.

Herein, a technique for determining a birthplace of a user of another account will be described. For example, a birthplace included in a profile (public information) of a user of another account may be determined as a birthplace of the user of the another account. In addition, a birthplace of a user of another account may be estimated by the technique described in the third example embodiment.

Another configuration of the information processing apparatus 1000 according to the present example embodiment is similar to that in the first to third example embodiments.

The information processing apparatus 1000 according to the present example embodiment can achieve an advantageous effect similar to that in the first to third example embodiments. Further, the information processing apparatus 1000 according to the present example embodiment can estimate not only an activity area of a user of an account but also whether each activity area is a birthplace, based on public information on social media. The information processing apparatus 1000 can generate such beneficial information, based on the public information.

### Fifth Example Embodiment

An information processing apparatus 1000 according to the present example embodiment estimates, by a technique different from that in the fourth example embodiment, what meaning an activity area has for a user of an account (user-activity area relationship), based on public information about a user of another account having a predetermined relationship with the user of the account. Details will be described below.

In general, a friendship and an activity area are narrower in a childhood or at a time of an elementary school student, a junior high school student, or a high school student than at a time of a college student or a working adult, and a person who becomes acquainted at a relatively close place such as an attended school and a neighborhood tends to become a friend. Thus, hobbies and preferences of a plurality of friends from a childhood or at a time of an elementary school student, a junior high school student, or a high school student tend to vary.

On the other hand, a friendship and an activity area are wider at a time of a college student or a working adult than in a childhood or at a time of an elementary school student, a junior high school student, or a high school student, and a person who has something in common such as a hobby and a preference tends to become a friend. Thus, hobbies and preferences of a plurality of friends at a time of a college student or a working adult tend to be similar.

Thus, the information processing apparatus 1000 according to the present example embodiment estimates a relationship (user-activity area relationship) between each activity area and a user of an account, based on a degree of variations in hobbies and preferences of a friend in each activity area.

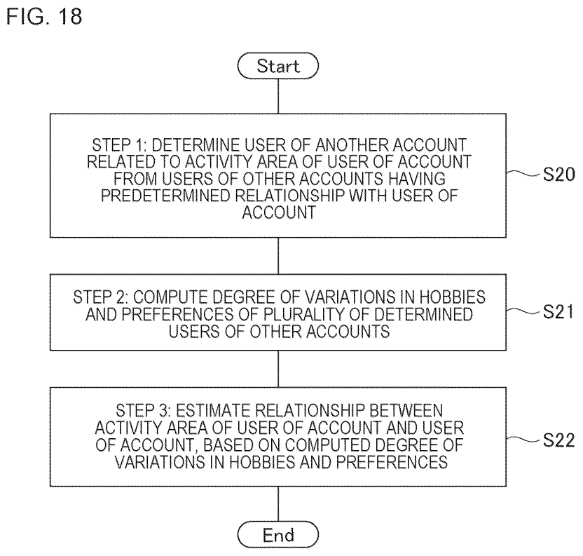

A relationship estimation unit 1002 performs steps 1 to 3 illustrated in a flowchart in FIG. 18.

In step 1, the relationship estimation unit 1002 determines a user of another account related to an activity area of a user of an account among users of other accounts having a predetermined relationship with the user of the account (S20). When the activity area of the user of the account can be handled by being divided into a plurality of sub-areas, the relationship estimation unit 1002 determines, for each sub-area, a user of another account related to each of the sub-areas.

A “user of another account related to an activity area of a user of an account” can include, for example, at least any of a “user in which his/her activity area is included in the activity area of the user of the account”, a “user in which any post place in his/her post material is included in the activity area of the user of the account”, a “user in which a predetermined proportion or more of post places in his/her post materials is included in the activity area of the user of the account”, a “user in which a birthplace or a current residence included in a profile is included in the activity area of the user of the account”, and a “user in which belonging or a location of an alma mater included in a profile is included in the activity area of the user of the account”.

Step 2 is performed after the user of the another account related to the activity area of the user of the account is determined. In step 2, the relationship estimation unit 1002 computes a degree of variations in hobbies and preferences of a plurality of the determined users of the other accounts (S21).

A hobby and a preference of a user of another account can be estimated based on public information (such as a profile and a post material) being published in association with the user of the another account. For example, a hobby and a preference may be estimated based on a frequency of occurrence of a word (such as baseball, soccer, music, piano, ice cream, doughnut, and bread) related to each of a plurality of hobbies and preferences in public information, or may be estimated by another technique.

A degree of variations in hobbies and preferences can be indicated by, for example, information entropy, which is not limited thereto.

Step 3 is performed after a degree of variations in hobbies and preferences of the plurality of determined users of the other accounts is computed. In step 3, the relationship estimation unit 1002 estimates a relationship (user-activity area relationship) between the activity area of the user of the account and the user of the account, based on the computed degree of variations in hobbies and preferences (S22).

When hobbies and preferences of the plurality of users of the other accounts related to the activity area vary at a reference level or more, the relationship estimation unit 1002 estimates that the activity area is an area where the user of the account is active in a childhood or at a time of an elementary school student, a junior high school student, or a high school student, i.e., a birthplace of the user of the account.

Further, when hobbies and preferences of the plurality of users of the other accounts related to the activity area do not vary at a reference level or more, the relationship estimation unit 1002 estimates that the activity area is an area where the user of the account is active at a time of a college student or a working adult, i.e., not a birthplace of the user of the account.

Another configuration of the information processing apparatus 1000 according to the present example embodiment is similar to that in the first to fourth example embodiments.

The information processing apparatus 1000 according to the present example embodiment can achieve an advantageous effect similar to that in the first to fourth example embodiments. Further, the information processing apparatus 1000 according to the present example embodiment can estimate not only an activity area of a user of an account but also whether each activity area is a birthplace, based on public information on social media. The information processing apparatus 1000 can generate such beneficial information, based on the public information.

### Sixth Example Embodiment

In the present example embodiment, a method for estimating an activity area of a user of an account is embodied. In the present example embodiment, an activity area estimation unit 1001 is achieved by an estimation apparatus 10 described below. Another configuration of an information processing apparatus 1000 according to the present example embodiment is similar to that in the first to fifth example embodiments.

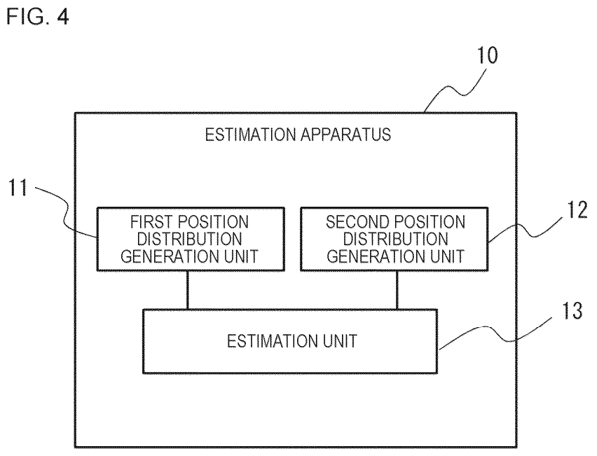

FIG. 4 illustrates an overview of the estimation apparatus 10. The estimation apparatus 10 is an apparatus that estimates an activity position of a target user in a physical space (also referred to as a “real world”, a “real space”, and the like) by using information on social media. As illustrated in FIG. 4, the estimation apparatus 10 includes a first position distribution generation unit 11, a second position distribution generation unit 12, and an estimation unit 13. The first position distribution generation unit 11 generates a first position distribution of a target user, based on account information about the target user on social media. For example, the first position distribution generation unit 11 may generate a post distribution, based on post information (post place) about the target user. The “post information” is synonymous with a “post material” in the first to fifth example embodiments.

The second position distribution generation unit 12 generates a second position distribution of a friend, based on account information about the friend having a relationship with the target user on social media. For example, the second position distribution generation unit 12 may generate a friend distribution, based on activity base information (residence information) about the friend. The “friend having a relationship with a target user on social media” is synonymous with a “user of another account having a predetermined relationship with a user of each account” in the first to fifth example embodiments.

The estimation unit 13 estimates an activity position of the target user, based on the generated first position distribution and the generated second position distribution. For example, the estimation unit 13 may estimate an activity position of the target user according to overlapping between the first position distribution and the second position distribution. Further, the first position distribution and the second position distribution may be generated by a nonparametric technique such as a kernel density estimation function, and an activity position may be estimated. Any one of the first position distribution and the second position distribution may be generated by the nonparametric technique. An activity position to be estimated may be an activity area, may be an ordinary activity place (such as a residence, a workplace, a store visited for a purpose of shopping, eating and drinking, and the like, and a movement route therebetween) visited by the target user in an everyday life, or may be an extraordinary activity place (such as a tourist site and a hotel at a time of travel and a business trip, and a movement route) not visited by the target user in an everyday life.

In this way, in the present example embodiment, an activity position (activity area) of a target user can be estimated with less information by using a position distribution by account information about the target user and a position distribution by account information about a friend. For example, an activity area may be able to be estimated when either one of post information about a target user and friend information about a friend can be used. When two kinds of information can be used, an activity area can be more accurately estimated by combining the pieces of information. Further, a collection cost of social data having a limitation on data collection can be reduced by using the nonparametric technique that does not need data collection on a large scale. Further, the information processing apparatus 1000 according to the present example embodiment can achieve an advantageous effect similar to that in the first to fifth example embodiments.

Hereinafter, 6-1st to 6-4th example embodiments acquired by further embodying the sixth example embodiment will be described.

### 6-1St Example Embodiment

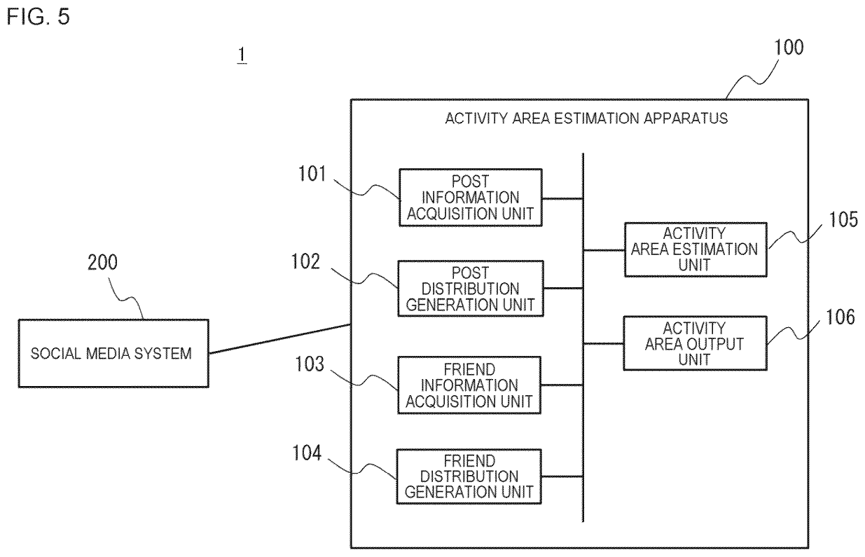

Hereinafter, the 6-1st example embodiment will be described with reference to the drawings. FIG. 5 illustrates a configuration example of an activity area estimation system 1 according to the present example embodiment. As illustrated in FIG. 5, the activity area estimation system 1 according to the present example embodiment includes an activity area estimation apparatus 100 (one example embodiment of the estimation apparatus 10) and a social media system 200.

The social media system 200 is a system for providing a social media service such as an SNS. The social media system 200 may include a plurality of social media services. The social media service is an online service that can send (publish) information between a plurality of accounts (users) on the Internet (online), and perform communication. The social media service is not limited to an SNS, and includes a messaging service such as a chat, a blog, an electronic bulletin board (forum site), a video sharing site, an information sharing site, a social game, a social bookmark, and the like.

For example, the social media system 200 includes a server on a cloud and a user terminal. The server may be a social media server or a web server. In the user terminal, a login is performed with an account of a user via an application programming interface (API) provided by the server, an input, viewing, and the like of a post are performed, and a connection between accounts such as a friendship and a following relationship is registered. The social media system 200 and the activity area estimation apparatus 100 are communicably connected to each other via the Internet and the like.

The activity area estimation apparatus 100 includes a post information acquisition unit 101, a post distribution generation unit 102, a friend information acquisition unit 103, a friend distribution generation unit 104, an activity area estimation unit 105, and an activity area output unit 106. Note that, a configuration of each unit (block) is one example, and other each unit may be used for a configuration as long as an operation (method) described below can be achieved. Further, each unit may be included in one apparatus, or may be included in a plurality of apparatuses. For example, the post information acquisition unit 101 and the post distribution generation unit 102 may be set as a first position distribution generation unit, and the friend information acquisition unit 103 and the friend distribution generation unit 104 may be set as a second position distribution generation unit.

The post information acquisition unit (target account information acquisition unit) 101 acquires post information about a target account from the social media system 200. The post information acquisition unit 101 is also a target account determination unit that determines a target account of a target user in which an activity area is estimated. The post information acquisition unit 101 acquires account information (social media information) about the determined target account from the social media system 200. The account information is synonymous with “public information” in the first to fifth example embodiments, and includes profile information, post information, and the like about an account. The post information acquisition unit 101 may acquire account information on a plurality of social media. The post information acquisition unit 101 may acquire account information from a server that provides a social media service via an API and a crawler (acquisition tool), or may acquire account information from a database that stores account information on social media in advance.

The post information acquisition unit 101 acquires all pieces of the post information (synonymous with a post material) from the account information about the target account. The post information includes an image, text, and the like being posted on a timeline and the like by an account (user). The post information acquisition unit 101 extracts a post place and a post date and time from the image and the text in the acquired post information. The post place is a place where the target user posted the post information, and the post date and time is a date and time at which the target user posted the post information. The post date and time is registered in association with the posted image and the posted text at the time of posting. The post place is position information that can be extracted from the post information, and may be a geotag such as global positioning system (GPS) information provided to the post image, or may be a position determined from unexpected capturing such as a landmark in the post image. Further, the post place may be a place mentioned in a post sentence (text) instead of an image. The place mentioned in the post sentence is extracted by, for example, natural language processing of the post sentence. Note that, the post place is one example of position information for estimating an activity place (place having some connection) of the target user from the account information about the target user, and an activity base such as a residence included in profile information may be used instead of the post place.

The post distribution generation unit 102 generates a post distribution (first position distribution) of the target account, based on the post information about the target account. The post distribution generation unit 102 generates a post distribution of the extracted post place of the target account. The post distribution is a distribution (spatial distribution unique to the post place) of a post place (post position) in a physical space, and is, for example, a two-dimensional geographical spatial distribution formed of coordinates of latitude and longitude. For example, the post distribution is a distribution of a post place in a distribution area unit having a predetermined size. A particle size level of a distribution area may be an administrative district unit such as a country unit, a prefectural unit, and a municipal unit, or may be a mesh unit having a predetermined size such as 1 km×1 km, 100 m×100 m, and 10 m×10 m.

The post distribution generation unit 102 acquires the post distribution by a predetermined distribution function. A density estimation function that estimates a distribution by the nonparametric technique is preferably used. In the present example embodiment, a kernel density estimation function is used as an example of the density estimation function of the nonparametric technique. In generation (computation) of a post distribution, weighting may be performed on each piece of post information, based on the post information. For example, weighting may be performed on post information by a post date and time. Note that, a post distribution may be acquired by the other statistical processing instead of a distribution function. For example, a post distribution (histogram) may be generated by counting the number of post places included in each distribution area.

The friend information acquisition unit 103 acquires friend information about a friend account from the social media system 200. The friend information acquisition unit 103 is also a friend account determination unit that determines a friend account of a target user. The friend account is an account having a connection such as a friendship with a target account in social media. The friend account may be an account of the same social media as a target user, or may be an account of different social media. For example, the friend account is an account having a friendship being registered in a target account, but may be an account (related account) having the other connection (relationship) with the target account. The “related account” is synonymous with “another account having a predetermined relationship with a user of each account” in the first to fifth example embodiments. The related account may be, for example, an account in which a connection of a follow relationship (following or follower), a connection by a post (such as a comment on a post, a quotation such as a retweet, a reaction such as “like”, and a mention by “mention”), a history of exchanging messages, and the like are present between the target account and the related account. Note that, the retweet is a post of a comment and the like in a form of quoting a post of another account or a post of his/her own account. The mention is posting a comment and the like including a specific account name.

The friend information acquisition unit 103 acquires account information about the determined friend account from the social media system 200. An information acquisition method from the social media system 200 is similar to that of the post information acquisition unit 101, and acquires account information by an API and the like of a server. The friend information acquisition unit 103 extracts friend information from all pieces of the acquired account information about the friend account. The friend information is position information about the friend account, and is, for example, a residence (residential area) extracted from the account information. The friend information acquisition unit 103 extracts residence information from profile information included in the account information. The other activity base such as a birthplace, a workplace, and a school may be extracted instead of a residence. Note that, the friend information is one example of position information for estimating an activity place (place having some connection) of the friend from the account information about the friend, and a post place and the like of post information may be used instead of an activity base such as a residence.

The friend distribution generation unit 104 generates a friend distribution (second position distribution) of the friend account, based on the friend information (activity base) about the friend account. The friend distribution generation unit 104 generates a friend distribution of the extracted residence of the friend account. The friend distribution is a distribution of a residence (friend position) of the friend in a physical space (spatial distribution unique to a residence of the friend), similarly to the post distribution. A particle size level of a distribution area of the friend distribution is the same as that of the post distribution, but may be a different particle size. The friend distribution generation unit 104 acquires a friend distribution by a distribution function of the nonparametric technique such as the kernel density estimation function, similarly to the post distribution generation unit 102, but may acquire a friend distribution by the other statistical processing. In generation (computation) of a friend distribution, weighting may be performed on each piece of residence information, based on the residence information.

The activity area estimation unit 105 estimates an activity area of the target user, based on the generated post distribution and the generated friend distribution. The activity area estimation unit 105 generates an activity area distribution of the target user by overlapping the post distribution and the friend distribution. A particle size level of the activity area distribution to be generated is the same particle size as that of the post distribution and the friend distribution (or either), but may be a different particle size. The activity area estimation unit 105 estimates an activity area according to overlapping (overlapped amount) between the post distribution and the friend distribution. The overlapping between the distributions is indicated by scores of the post distribution and the friend distribution each acquired by the kernel density estimation function. In other words, an activity area is estimated based on a score of the post distribution acquired by the kernel density estimation function and a score of the friend distribution acquired by the kernel density estimation function. The activity area estimation unit 105 estimates an activity area, based on a predetermined computation result of the score of the post distribution and the score of the friend distribution each acquired by the kernel density estimation function. For example, a product of the score of the post distribution and the score of the friend distribution is taken, and an area having a highest score is set as an activity area. Note that, addition, subtraction, and the like may be performed instead of a product. An ordinary activity area of the target user can be estimated from a product or addition of the score of the post distribution and the score of the friend distribution. An extraordinary activity area can be estimated by subtracting the score of the friend distribution from the score of the post distribution. The activity area estimation unit 105 may set, as the activity area, an area whose acquired score is equal to or more than a predetermined value, or may set, as the activity area, an area whose score is in top N (such as top five).

The activity area output unit 106 outputs the estimated activity area. The activity area may be displayed in a predetermined form with the activity area output unit 106 as a display apparatus by a graphical user interface (GUI). The post distribution and the friend distribution may be displayed, and an area where the distributions overlap each other may be displayed in an emphasized manner. For example, a score of each activity area may be displayed in a heat map form. Further, the activity area may be output as a file in a predetermined form to the outside. For example, a score of each activity area may be output in a list form, and only a predetermined number may be output.

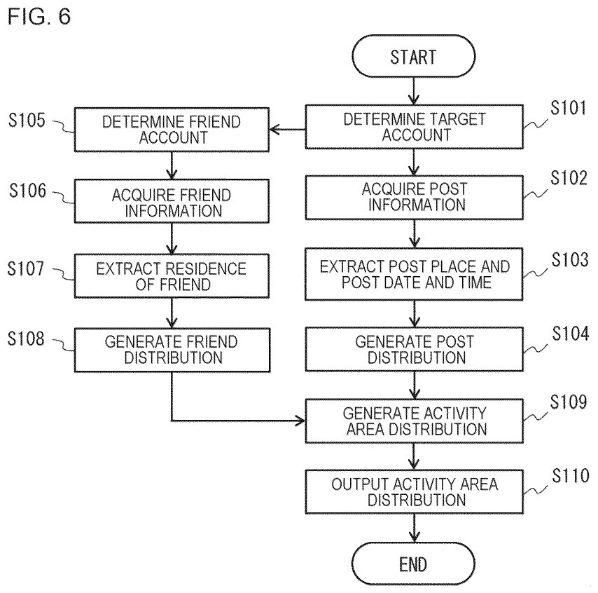

FIG. 6 illustrates one example of an operation (activity area estimation method) of the activity area estimation apparatus according to the present example embodiment. As illustrated in FIG. 6, first, the activity area estimation apparatus 100 determines a target account of a target user (S101). The post information acquisition unit 101 receives an input of information about the target account, and determines the target account, based on the input information. The account may be determined by inputting an account ID (identification information) of the target account, or the account may be determined by a search on social media or the Internet from an input name, an input keyword, and the like.

Subsequently, the activity area estimation apparatus 100 acquires post information about the target account (S102). The post information acquisition unit 101 accesses a server or a database of the social media system 200, and acquires account information about the target account being published and acquirable. For example, the account information about the target account is acquired in a possible range by an API and the like of a social media service. The post information acquisition unit 101 acquires all pieces of the post information included in the account information about the target account.

Subsequently, the activity area estimation apparatus 100 extracts a post place and a post date and time of the post information (S103). The post information acquisition unit 101 extracts the post place and the post date and time from all pieces of the post information about the target account. Note that, a post place and a post date and time may be extracted from some pieces of the post information instead of all pieces of the post information. For example, post information older than a predetermined date and time may fall outside extraction, and one of two pieces of post information having the same post content may fall outside extraction. When a geotag is provided to a post image, the post information acquisition unit 101 acquires a post place (position information) from the geotag. When a geotag is not provided to a post image, an image analysis may be performed on unexpected capturing in the post image, and a post place may be acquired from a building, a scene, and the like from which a position can be determined. When position information cannot be acquired from a post image, natural language processing may be performed on text of a post sentence, and a post place may be acquired from a word from which a position can be determined. When a post place cannot be acquired from post information, the post information acquisition unit 101 may exclude the post information from information for generating a post distribution. Further, the post information acquisition unit 101 acquires a date and time provided to the post information as a post date and time.

Subsequently, the activity area estimation apparatus 100 generates a post distribution of the target account (S104). The post distribution generation unit 102 generates the post distribution, based on the extracted post place and the extracted post date and time of the plurality of pieces of post information. In this example, the post distribution generation unit 102 acquires a post distribution p(Lₚ) by the following equation (1) by using the kernel density estimation function. The post distribution p(Lₚ) is a group of kernel density estimation values (scores) of post information about each distribution area.

$$[ Mathematical 1 ]$$

$$p ( {L}_{p} ) = \frac{1}{\vert p \vert {h}_{p}} {\sum }_{1}^{p} {w}_{p} {K}_{p} ( {l}_{p} ) \qquad ( 1 )$$

In the equation (1), lₚ is a group of post places, hₚ is a post band width, wₚ is a post weight, and Kₚ is a post kernel function. The band width is a parameter indicating an influence range of each sample in kernel density estimation. The post band width is a predetermined value for a post distribution, and may be preset or may be a value acquired by learning from a plurality of post places in advance. The post band width may be changed according to an output activity area (estimation result).

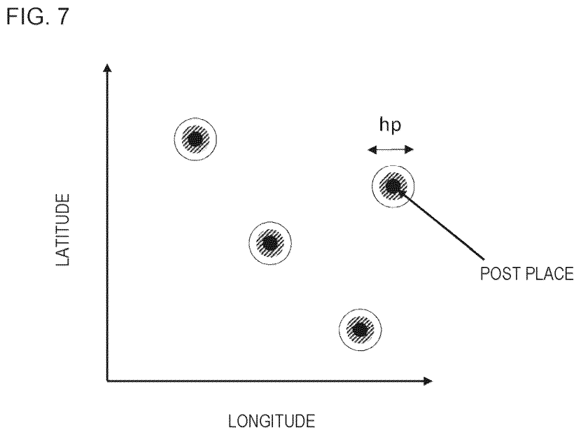

FIG. 7 illustrates an image of a post distribution acquired by kernel density estimation. As illustrated in FIG. 7, a distribution is acquired by plotting a post place of each piece of post information on two-dimensional coordinates of latitude and longitude, and indicating an influence range (for example, a circle of a normal distribution) of a post band width with the post place as the center. The influence range of each post place (sample) has a highest score at the center (post place) and has a lower score at a greater distance from the center. In the example of the drawing, a higher score is indicated in a darker color.

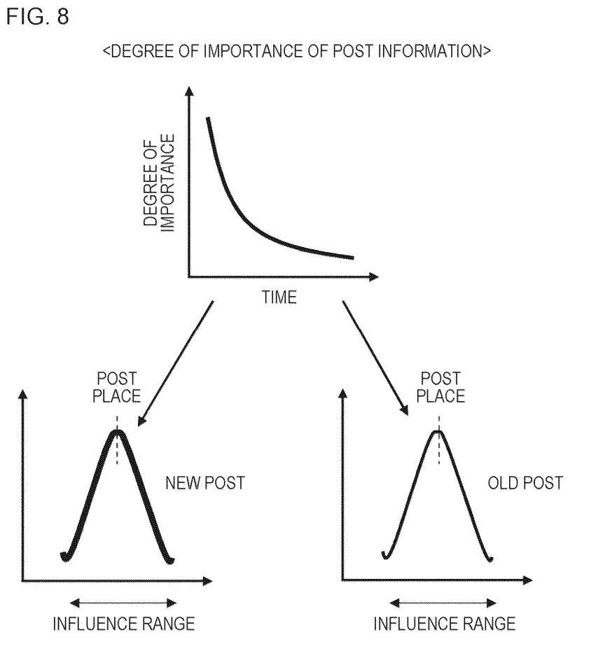

The post weight in the equation (1) is a weight of post information in a post distribution, based on each piece of the post information. The post weight indicates a degree of importance of each piece of the post information and sets a level of a score. As one example, the post weight is a weight based on a post date and time of the post information. For example, as illustrated in FIG. 8, a degree of importance of the post information and an elapsed time are in an inversely proportional relationship, and the degree of importance decreases with a lapse of time. Thus, a weight is greater (importance is higher) for newer post information, and a weight is smaller (importance is lower) for older post information. By changing the weight in the equation (1) according to a post date and time, a score can be set higher for newer information and a score can be set lower for older information while the influence range is invariable.

Meanwhile, subsequent to determination of the target account (S101), the activity area estimation apparatus 100 determines a friend account (S105). The friend information acquisition unit 103 determines the friend account having a friendship and the like with the target account from the account information about the target account. For example, an account registered in a friendship in the account information about the target account is set as a friend account. Further, an account having a relationship such as following and follower of a post of the target account, an account having post information that quotes post information about the target account, an account that provides “like” and the like to post information about the target account, and an account having a history of exchanging messages may be set as a friend account or a user of another account that has been at the same place at the same timing as the user of the target account.

Subsequently, the activity area estimation apparatus 100 acquires friend information about the friend account (S106). The friend information acquisition unit 103 acquires all pieces of account information about the friend account in a possible range by an API and the like of a social media service from the server and the like of the social media system 200, similarly to acquisition of the account information about the target account.

Subsequently, the activity area estimation apparatus 100 extracts residence information about the friend account (S107). The friend information acquisition unit 103 extracts the residence information from all pieces of the acquired account information about the friend account. The friend information acquisition unit 103 acquires profile information of the account information about the friend, and acquires the residence information registered in the profile information. When a residence cannot be acquired from the profile information, an activity base such as a birthplace, a workplace, and a school registered in the profile information may be set as residence information. A post place may be extracted from post information, and a place having a high frequency of being a post place may be set as residence information. Further, when residence information cannot be acquired from the account information about the friend account, a residence of the friend may be estimated from account information about a friend (another friend) of the friend further having a friendship with the friend. For example, a residence of the friend may be estimated based on a distribution of a residence acquired from account information about a further friend of the friend. In other words, a friend distribution may be generated based on a residence of the friend determined from a residence of a further friend of the friend. When the residence information about the friend account cannot be acquired, the friend information acquisition unit 103 may exclude information about the friend account from information for generating a friend distribution.

Subsequently, the activity area estimation apparatus 100 generates a friend distribution of the friend account (S108). The friend distribution generation unit 104 generates the friend distribution, based on a plurality of pieces of the extracted residence information about the friend account. In this example, the friend distribution generation unit 104 acquires a friend distribution p(L_{f}) by the following equation (2) by using the kernel density estimation function, similarly to the post distribution. The friend distribution p(L_{f}) is a group of kernel density estimation values (scores) of friend information about each distribution area.

$$[ Mathematical 2 ]$$

$$p ( {L}_{f} ) = \frac{1}{\vert f \vert {h}_{f}} {\sum }_{1}^{f} {w}_{f} {K}_{f} ( {l}_{f} ) \qquad ( 2 )$$

In the equation (2), l_{f} is a group of residences of friends, h_{f} is a friend band width, w_{f} is a friend weight, and K_{f} is a friend kernel function. The friend band width is a predetermined value for a friend distribution, and may be preset or may be a value acquired by learning from residences of a plurality of friends, similarly to the post band width. The friend band width may be different from or the same as the post band width. The friend band width may be changed according to an output activity area (estimation result).

The friend weight in the equation (2) is a weight of friend information (residence) in a friend distribution, based on each piece of the friend information (account information). The friend weight indicates a degree of importance of each piece of the friend information and sets a level of a score. As one example, the friend weight may be a weight based on a period in which the target user became a friend (a friendship was formed, a connection was made). For example, when a date and time at which the target user became a friend can be acquired, a weight on old friend information is set small (not seriously considered), and a weight on a new friend is set great (seriously considered). The reason is that an old friend may live near an original address when the target user has moved. Note that, conversely, weighting may be performed in such a way that a new friend is not seriously considered. For example, when there is a dream town or a town desired to be lived, it is estimated that a person who lives in the town has become a friend before moving for collecting information about the town, and, in such a case, an old friend may be seriously considered. As a specific computation method, for example, an initial value (100) may be set as a value of a weight, and the value of the weight may be reduced based on an elapsed time since the target user has become a friend. In a simple example, a weight may be acquired by a linear function as in weight=ax+b (a is a negative value, x is the number of elapsed days, and b is an initial value of 100). Further, a fixed reference day may be provided, and a fixed weight may be provided when the target user has become a friend within x days, and a weight may not be provided when the target user has become a friend before x days.

Further, the friend weight may be a weight by a frequency of a conversation such as the number of mentions and the number of retweets for the account of the target user. For example, a friend having a higher frequency of a conversation with the target user than another friend has a greater weight (is seriously considered). As a specific computation method, a weight may be provided to the friend by setting a total number of conversations of the target user as a denominator and setting the number of conversations with each friend as a numerator, a weight may be provided to a friend having a predetermined number or more of times of conversations, or a weight may not be provided to a friend who does not satisfy a fixed number of times.

Furthermore, the friend weight may be a weight based on a degree of reliability of a friend account. Since a fake account that uses false information is present among social media users, when such a fake account is included in a friend, estimation may be performed without seriously considering information about the friend. The degree of reliability indicates a degree of reliability of an account, and a higher degree of reliability increases reliability. The degree of reliability may be a numerical index acquired by a distance. The activity area estimation apparatus 100 may further include a reliability degree computation unit (not illustrated), and the reliability degree computation unit may acquire a degree of reliability, based on person attribute information about an account. For example, the reliability degree computation unit acquires person attribute information (information such as a profile) about a determination target account from which a degree of reliability is acquired, and person attribute information about a friend account of the determination target account, and estimates a person attribute of the determination target account from the person attribute information about the friend account. When a residence is included in the person attribute information about the friend account, a residence of a user of the determination target account is estimated based on a physical distance from the residence. Furthermore, a degree of reliability is computed based on a distance between the acquired person attribute information (residence) about the determination target account and the estimated person attribute information (residence) about the determination target account. For example, the degree of reliability (or a value based on the degree of reliability) acquired by the reliability degree computation unit is set as a friend weight.

Further, the friend weight may be a weight based on a degree of an off-line friend of a friend. The off-line friend is a friend having a friendship (having a connection) with the target user also in a physical space (real world) among friend accounts having a friendship with the target user on social media. Estimation may be performed by more seriously considering information about the off-line friend than information about an online friend. The degree of an off-line friend indicates whether a relationship with the off-line friend is formed also in the physical space. The activity area estimation apparatus 100 may further include an off-line friend discrimination unit, and the off-line friend discrimination unit may compute a score indicating a degree of an off-line friend for each friend account of the target user. The off-line friend discrimination unit and a specific example of a method for computing a degree of an off-line friend will be described in the example embodiments described below. For example, the degree of an off-line friend (or a value based on the degree of an off-line friend) acquired by the off-line friend discrimination unit is set as a friend weight.

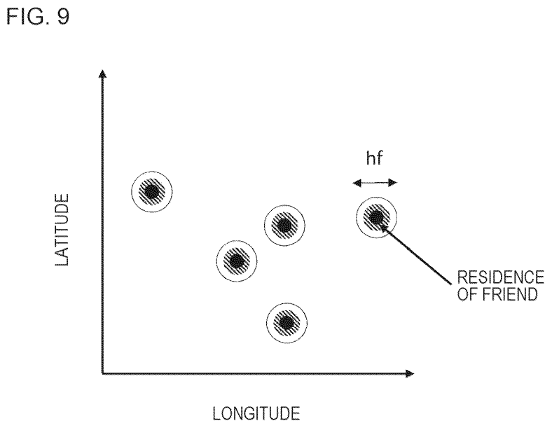

FIG. 9 illustrates an image of a friend distribution acquired by kernel density estimation. As illustrated in FIG. 9, a distribution is acquired by plotting a residence of each friend on two-dimensional coordinates of latitude and longitude, and indicating an influence range (for example, a circle of a normal distribution) of a friend band width with the residence of the friend as the center, similarly to the post distribution.

Subsequent to generation of the post distribution and generation of the friend distribution, the activity area estimation apparatus 100 generates an activity area distribution of the target user (S109). The activity area estimation unit 105 generates the activity area distribution of the target user by overlapping the post distribution and the friend distribution in the same area (space). For example, the activity area estimation unit 105 estimates an activity area lₜ (estimated activity area) of the target user by taking a product of the post distribution and the friend distribution acquired from the equation (1) and the equation (2) described above as in the following equation (3) and equation (4).

$$[ Mathematical 3 ]$$

$${l}_{t} = arg max p ( L ) , \qquad ( 3 )$$

$$[ Mathematical 4 ]$$

$$p ( L ) ∝ \{ \frac{1}{\vert f \vert {h}_{f}} {\sum }_{1}^{f} {w}_{f} {K}_{f} ( {l}_{f} ) \} \{ \frac{1}{\vert p \vert {h}_{p}} {\sum }_{1}^{p} {w}_{p} {K}_{p} ( {l}_{p} ) \} \qquad ( 4 )$$

In the equation (3), L is a group of l_{f} and lₚ. As in the equation (4), a score p(L) of each distribution area is proportional to a score of the post distribution and a score of the friend distribution, and, as in the equation (3), an area having the highest score p(L) is estimated as an activity area.

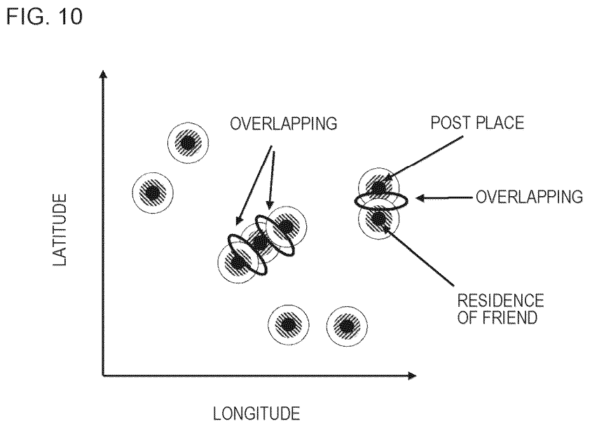

FIG. 10 illustrates an image in which a post distribution and a friend distribution overlap each other on the same space (coordinates). As illustrated in FIG. 10, an influence range of each place of the post distribution and an influence range of each place of the friend distribution overlap each other. A place where a distribution of a residence of a friend and a distribution of a post place overlap each other is an activity area, and a place (darker place) having a greater overlapped amount is considered as an activity area.

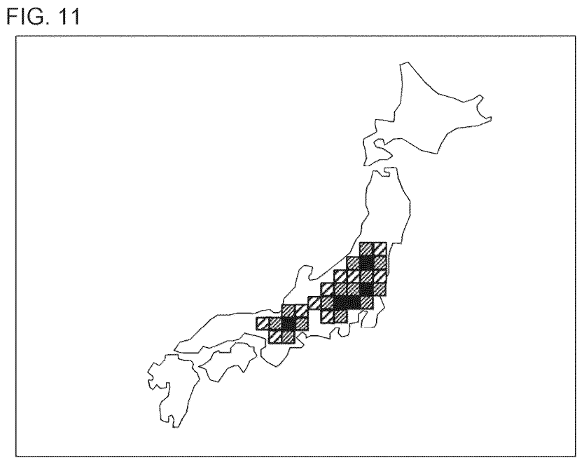

Subsequently, the activity area estimation apparatus 100 outputs the generated activity area distribution (S110). The activity area output unit 106 performs display and the like on the generated activity area distribution in a predetermined form. FIG. 11 illustrates a display example of an activity area distribution. As illustrated in FIG. 11, for example, the activity area distribution

n is displayed by a heat map. In the heat map, a distribution of color and darkness according to a score of each area is displayed on a map (such as a world map, a Japan map, and a regional map).

As described above, in the present example embodiment, a place where a trace of an activity is greater, such as a place having some connection, is considered as an activity area. Specifically, a distribution based on friend information (residence) and a distribution based on post information (post place) are each generated simultaneously, and an activity area distribution of a target user is generated by overlapping the distributions.

In the present example embodiment, large-scale data do not need to be prepared by using an estimation technique that does not need an advance model preparation. Specifically, kernel density estimation that does not need parameter learning using massive data is used. Further, a data collection cost can be reduced by limiting information used for estimation to a friend residence of a target user and a post place of the target user himself/herself. Furthermore, a collection cost can be reduced at both times of learning and estimation.

Further, in the present example embodiment, an activity area of a target user can be estimated by two kinds of information. Specifically, information used for estimation is a friend residence of a target user and a post place of the target user himself/herself. In this way, an activity area can also be estimated for a target user from which only one piece of the information can be acquired. Further, a collection cost can be suppressed by narrowing the two kinds of information described above.

### 6-2Nd Example Embodiment

Hereinafter, the 6-2nd example embodiment will be described with reference to the drawings. In the present example embodiment, an example of filtering post information and friend information in the activity area estimation apparatus 100 in the 6-1st example embodiment will be described.

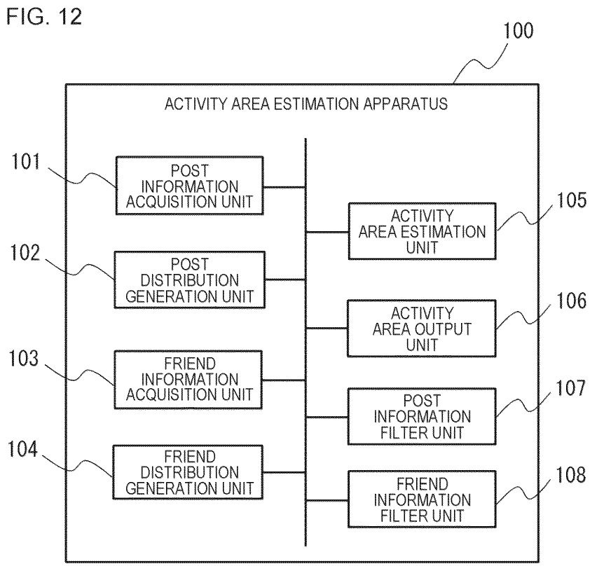

FIG. 12 illustrates a configuration example of an activity area estimation apparatus 100 according to the present example embodiment. As illustrated in FIG. 12, the activity area estimation apparatus 100 according to the present example embodiment includes a post information filter unit 107 and a friend information filter unit 108 in addition to the configuration in the 6-1st example embodiment.

The post information filter unit 107 filters, on a predetermined condition, post information about a target account acquired by the post information acquisition unit 101. The post information filter unit 107 is a selection unit (first selection unit) that selects post information to be used for generation of a post distribution from a plurality of pieces of post information included in account information about a target user. The post information filter unit 107 selects post information, based on a particle size of a post place, and, for example, excludes post information in which a particle size of a post place is greater than a predetermined particle size level. As a specific example, post information having a particle size in a country unit or a prefectural unit greater than a municipal unit may be excluded, or post information having a predetermined size in a unit of 1 km×1 km or a unit of 100 m×100 m greater than a unit of 10 m×10 m may be excluded.

The friend information filter unit 108 filters, on a predetermined condition, friend information about a friend account acquired by the friend information acquisition unit 103. The friend information filter unit 108 is a selection unit (second selection unit) that selects residence information to be used for generation of a friend distribution from a plurality of pieces of residence information (activity base information) included in account information about a friend. The friend information filter unit 108 selects residence information, based on a particle size of residence information, and, for example, excludes friend information in which a particle size of the residence information is greater than a predetermined particle size level.

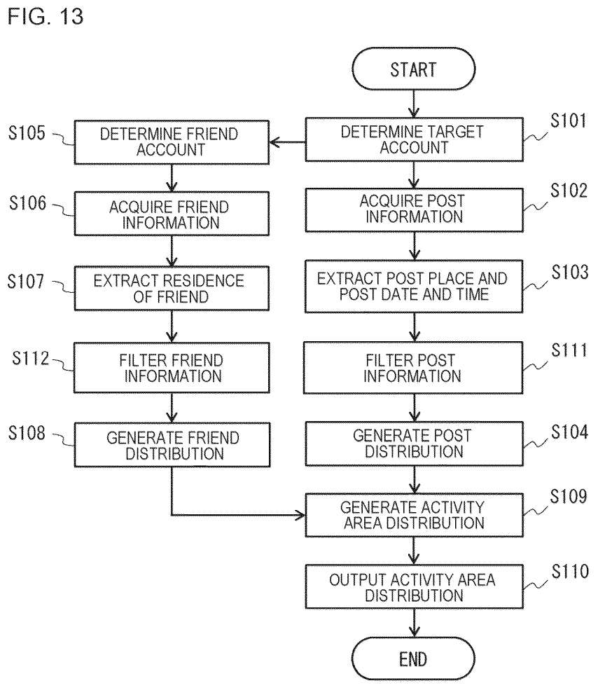

FIG. 13 illustrates an operation example of the activity area estimation apparatus according to the present example embodiment. As illustrated in FIG. 13, after extraction of a post place and a post date and time (S103), the post information filter unit 107 filters post information (S111). When a particle size of the extracted post place of each piece of the post information is determined and the particle size of the post place is greater than a predetermined particle size level, the post information filter unit 107 excludes the post information from information for generating a post distribution. For example, the predetermined particle size level is a particle size level of a post distribution to be generated (or an activity area distribution to be output). Subsequently, the post distribution generation unit 102 generates a post distribution by the filtered post information, similarly to the 6-1st example embodiment (S104).

Note that, in this example, post information is filtered according to a particle size of a post place, but may be filtered by another reference. Post information may be filtered based on a post date and time and the like being used in a post weight in the 6-1st example embodiment. For example, post information in which a post date and time is older than a predetermined date and time may be excluded.

Further, in this example, a particle size of a post place is a reference of filtering, but a particle size of a post place may be a post weight in the 6-1st example embodiment. In other words, a post distribution may be generated by using a post weight (wₚ) as a weight based on a particle size level of a post place in the equation (1) described above. For example, a more detailed distribution can be generated with a smaller particle size of a post place. Thus, a weight may be increased with a smaller particle size of a post place, and a weight may be reduced with a greater particle size of a post place.

Meanwhile, after extraction of residence information about a friend (S107), the friend information filter unit 108 filters friend information (S112). Similarly to the post information, when a particle size of the extracted residence information about each friend is determined and the particle size of the residence information about the friend is greater than a predetermined particle size level, the filter information filter unit 108 excludes the friend information from information for generating a friend distribution. For example, the predetermined particle size level is a particle size level of a friend distribution to be generated (or an activity area distribution to be output). Subsequently, the friend distribution generation unit 104 generates a friend distribution by the filtered friend information, similarly to the 6-1st example embodiment (S108).

Note that, friend information may be filtered by another reference instead of a particle size of residence information, similarly to the post information. Friend information may be filtered based on a period of becoming a friend, a frequency of a conversation, a degree of reliability of a friend account, a degree of an off-line friend of a friend, and the like being used in a friend weight in the 6-1st example embodiment. For example, friend information in which a period of becoming a friend of a target user is older (or newer) than a predetermined date and time, friend information in which the number of conversations with the target user is equal to or less than a predetermined number of times, friend information in which a degree of reliability of a friend account is equal to or less than a predetermined value, friend information in which a degree of an off-line friend is equal to or less than a predetermined value, and the like may be excluded.

Further, similarly to the post information, a particle size of residence information is not limited to a reference of filtering, and may be a friend weight in the 6-1st example embodiment. In other words, a friend distribution may be generated by using a friend weight (wf) as a weight based on a particle size level of residence information (activity base) in the equation (2) described above in the 6-1st example embodiment. For example, similarly to the post information, a weight may be increased with a smaller particle size of residence information, and a weight may be reduced with a greater particle size of residence information.

As described above, in the present example embodiment, post information for generating a post distribution and friend information for generating a friend distribution are filtered based on each piece of the information. In this way, a distribution can be generated by information about a predetermined particle size level, and thus a distribution with desired accuracy can be acquired.

### 6-3Rd Example Embodiment

Hereinafter, the 6-3rd example embodiment will be described with reference to the drawings. In the present example embodiment, an example of performing weighting on a post distribution and a friend distribution to be overlapped in the activity area estimation apparatus 100 in the 6-1st or 6-2nd example embodiment will be described.

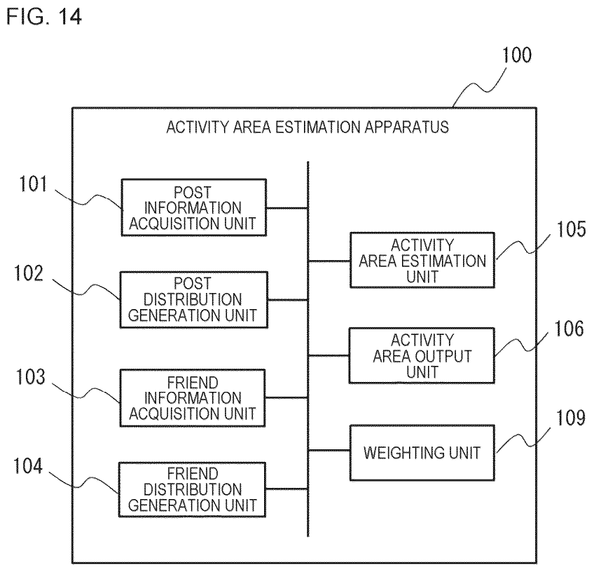

FIG. 14 illustrates a configuration example of an activity area estimation apparatus 100 according to the present example embodiment. As illustrated in FIG. 14, the activity area estimation apparatus 100 according to the present example embodiment includes a weighting unit 109 in addition to the configuration in the 6-1st example embodiment. The weighting unit 109 performs weighting (weighting of overlapping) on a post distribution and a friend distribution to be overlapped. For example, weighting may be performed on a friend distribution and a post distribution according to the number (sample number) of pieces of friend information of the friend distribution and the number (sample number) of pieces of post information of the post distribution, and weighting may be performed according to a difference between the number of the pieces of friend information and the number of the pieces of post information. Further, weighting may be performed on either a friend distribution or a post distribution. The activity area estimation unit 105 estimates an activity area of a target user, based on weighting of (or either of) the post distribution and the friend distribution.

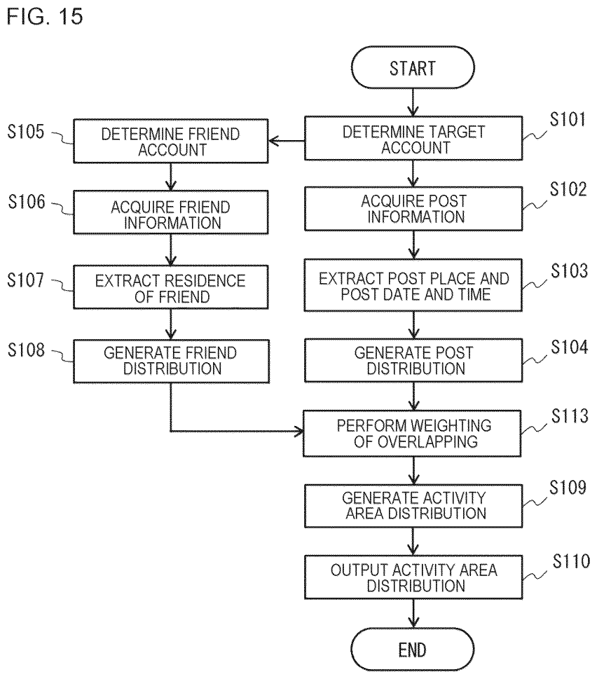

FIG. 15 illustrates an operation example of the activity area estimation apparatus according to the present example embodiment. As illustrated in FIG. 15, after generation of a post distribution (S104) and generation of a friend distribution (S108), the weighting unit 109 performs weighting of overlapping on the friend distribution and the post distribution (S113). The weighting unit 109 counts the number of pieces of post information (post places) of the generated post distribution and the number of pieces of friend information (residences) of the generated friend distribution, acquires a difference between the number of the pieces of post information and the number of the pieces of friend information, and performs weighting on the post distribution and the friend distribution according to the acquired difference. For example, when there is a great difference between the number of the pieces of post information and the number of the pieces of friend information, there is a risk that either of the pieces of information may be considered too seriously, and thus the number of the pieces of post information and the number of the pieces of friend information may be balanced. For example, when the number of friends is 100 and the number of posts is 200, a friend distribution and a post distribution may overlap each other in a proportion of 2 to 1.

Subsequently, the activity area estimation unit 105 generates an activity area distribution by overlapping the weighted post distribution and the weighted friend distribution (S109). For example, as in the following equation (5), a score p(L) is acquired by multiplying each of the distributions by a weight WF of the friend distribution and a weight WP of the post distribution.

$$[ Mathematical 5 ]$$

$$p ( L ) ∝ WF \{ \frac{1}{\vert f \vert {h}_{f}} {\sum }_{1}^{f} {w}_{f} {K}_{f} ( {l}_{f} ) \} \cdot WP \{ \frac{1}{\vert p \vert {h}_{p}} {\sum }_{1}^{p} {w}_{p} {K}_{p} ( {l}_{p} ) \} \qquad ( 5 )$$

As described above, in the present example embodiment, weighting is performed on each distribution at a time of overlapping a friend distribution and a post distribution. In this way, an activity area of a target user can be estimated by seriously considering either of the friend distribution and the post distribution. For example, an activity area can be estimated in a well-balanced manner by performing weighting, based on the number of friends and the number of posts.

### 6-4Th Example Embodiment

Hereinafter, the 6-4th example embodiment will be described with reference to the drawings. In the present example embodiment, an example of performing weighting on a distribution of an online friend and a distribution of an off-line friend will be described as another example of weighting of overlapping in the 6-3rd example embodiment.

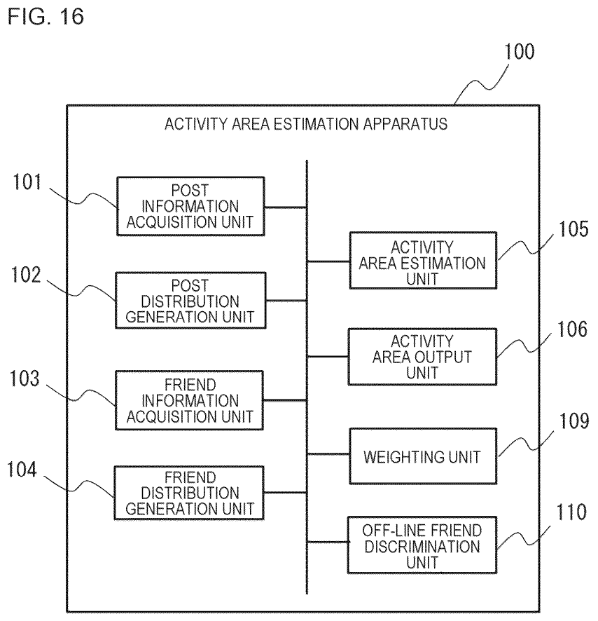

FIG. 16 illustrates a configuration example of an activity area estimation apparatus 100 according to the present example embodiment. As illustrated in FIG. 16, the activity area estimation apparatus 100 according to the present example embodiment includes an off-line friend discrimination unit 110 in addition to the configuration in the 6-3rd example embodiment. The off-line friend discrimination unit 110 discriminates an off-line friend having a friendship (having a connection) with a target user in a physical space (real world) from among friend accounts having a friendship with the target user on social media. In other words, an off-line friend and an online friend other than the off-line friend are discriminated from friends of the target user. The activity area estimation unit 105 estimates an activity area of the target user, based on a post distribution, a friend distribution of the off-line friend, and a friend distribution of the online friend. Further, an activity area is estimated based on weighting of the friend distribution of the off-line friend and the friend distribution of the online friend.

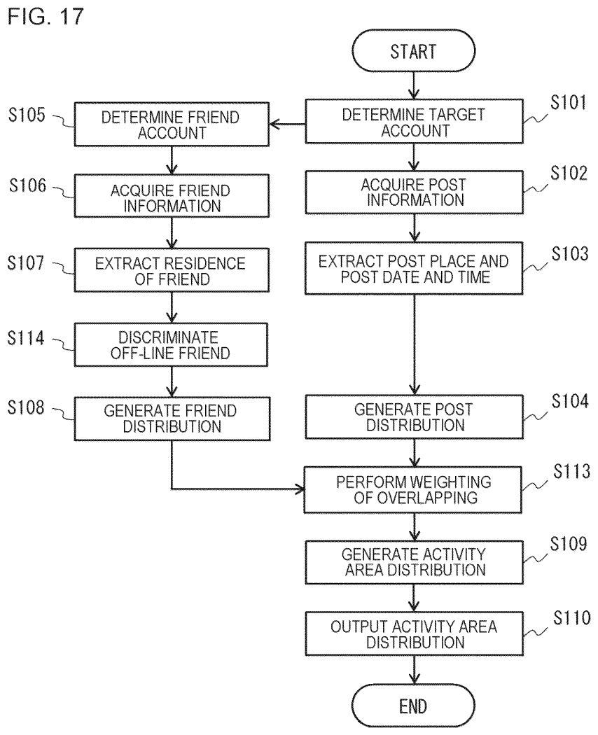

FIG. 17 illustrates an operation example of the activity area estimation apparatus 100 according to the present example embodiment. As illustrated in FIG. 17, after extraction of a residence of a friend (S107), the off-line friend discrimination unit 110 discriminates an off-line friend (S114). The off-line friend discrimination unit 110 determines, based on acquired account information about a friend account, whether each friend possessing the friend account is a friend of a target user also in a physical space or not a friend in the physical space. The off-line friend discrimination unit 110 acquires a degree of an off-line friend of the friend account, and discriminates an off-line friend or an online friend by the degree of an off-line friend. The off-line friend discrimination unit 110 computes a score indicating the degree of an off-line friend for each friend account of the target user, and sets the degree of an off-line friend as a value (for example, “1”) indicating the off-line friend when the score exceeds a fixed threshold value, or sets the degree of an off-line friend as a value (for example, “0”) indicating not the off-line friend when the score is equal to or less than the threshold value. The threshold value is set freely by, for example, a user of the activity area estimation apparatus 100.

The off-line friend discrimination unit 110 may determine whether a friend account is a local account related to a specific region. For example, the local account is an account of social media operated with certain specific place, region, and the like as targets among social media accounts. As an example of the local account, there is an account operated by a local newspaper, a local government, a community-based company such as a restaurant under private management. The off-line friend discrimination unit 110 may compute a degree of an off-line friend of a friend, based on a determination result of whether a friend account is a local account. For example, the off-line friend discrimination unit 110 may refer to friend information (profile information and post information) about a friend account, compute a score according to presence or absence of information indicating whether the account is operated with specific place and region as targets and an excess of the information, and determine whether the friend account is a local account.

Further, the off-line friend discrimination unit 110 may refer to further friend information about the friend account when whether the friend account is a local account is determined unknown, and may determine whether the friend account is a local account. For example, a degree of an off-line friend of the friend account of the target user may be computed based on whether an account of a further friend of the friend account is a local account. In addition, an off-line friend and an online friend may be discriminated by using the technique described in Non-Patent Document 1.

The friend distribution generation unit 104 generates a friend distribution of the discriminated off-line friend and a friend distribution of the online friend (S108). The friend distribution generation unit 104 generates the friend distribution of the off-line friend, based on residence information about the off-line friend, and generates the friend distribution of the online friend, based on residence information about the online friend, similarly to the 6-1st example embodiment.

Subsequently, the weighting unit 109 performs weighting on the generated friend distribution of the off-line friend and the generated friend distribution of the online friend (S113). For example, the off-line friend has a degree of importance related to an activity area of the target user higher than the online friend. Thus, weighting is performed in such a way that the friend distribution of the off-line friend is more seriously considered than the friend distribution of the online friend.

Subsequently, the activity area estimation unit 105 generates an activity area distribution by overlapping the weighted friend distribution of the off-line friend and the weighted friend distribution of the online friend with a post distribution (S109). Note that, an activity area distribution may be generated by overlapping only the friend distribution of the off-line friend and the post distribution. For example, as in the following equation (6), a score p(L) is acquired by multiplying each of the distributions by a weight WF_{off} of the friend distribution of the off-line friend and a weight WFₒₙ of the friend distribution of the online friend, and taking a product of the distributions and the post distribution. Note that, a friend weight in this case does not preferably include a weight based on a degree of an off-line friend.

$$[ Mathematical 6 ]$$

$$p ( L ) ∝ {WF}_{on} \{ \frac{1}{\vert f \vert {h}_{f 1}} {\sum }_{1}^{f} {w}_{f 1} {K}_{f} ( {l}_{f} ) \} \cdot \qquad ( 6 )$$

$${WF}_{off} \{ \frac{1}{\vert f \vert {h}_{f 2}} {\sum }_{1}^{f} {w}_{f 2} {K}_{f} ( {l}_{f} ) \} \cdot \{ \frac{1}{\vert p \vert {h}_{p}} {\sum }_{1}^{p} {w}_{p} {K}_{p} ( {l}_{p} ) \}$$

Note that, in the equation (6), h_{f1} and w_{f1} are values in the friend distribution of the online friend, and h_{f2} and w_{f2} are values in the friend distribution of the off-line friend. In other words, when the friend distribution for the off-line friend and the friend distribution for the online friend are generated, each band width and each friend weight may be a different value. In this way, the generated friend distribution and a friend distribution can be made different.

As described above, in the present example embodiment, a friend distribution is divided into a distribution of only an off-line friend and a distribution of only an online friend, and weighting is performed on the distribution of the off-line friend at a time of overlapping with a post distribution. In this way, an activity area of a target user can be estimated by seriously considering the friend distribution of the off-line friend.

While the example embodiments of the present invention have been described with reference to the drawings, the example embodiments are only exemplification of the present invention, and various configurations other than the above-described example embodiments can also be employed. The configurations of the example embodiments described above may be combined together, or a part of the configuration may be replaced with another configuration. Further, various modifications may be made in the configurations of the example embodiments described above without departing from the scope of the present invention. Further, the configurations and the processing disclosed in each of the example embodiments and the modification examples described above may be combined together.

Note that, in the present specification, “acquisition” includes at least any one of “acquisition of data stored in another apparatus or a storage medium by its own apparatus (active acquisition)”, based on a user input or an instruction of a program, such as reception by making a request or an inquiry to another apparatus and reading by accessing to another apparatus or a storage medium, “inputting of data output to its own apparatus from another apparatus (passive acquisition)”, based on a user input or an instruction of a program, such as reception of data to be distributed (transmitted, push-notified, or the like) and acquisition by selection from among received data or received information, and “generation of new data by editing data (such as texting, sorting of data, extraction of a part of data, and change of a file format) and the like, and acquisition of the new data”.

A part or the whole of the above-described example embodiment may also be described in supplementary notes below, which is not limited thereto.

1. An information processing apparatus including:
an activity area estimation unit that estimates an activity area of a user of an account of social media, based on public information being published on the Internet in association with the account; and
a relationship estimation unit that estimates a relationship between a user of the account and the activity area, based on the public information.

2. The information processing apparatus according to supplementary note 1, wherein
the public information includes a post material being posted on the Internet by a user of the account, and
the relationship estimation unit
   estimates a post place of the post material, and
   estimates a period in which a user of the account is active in the activity area, based on a post period of the post material in which the post place is included in the activity area.

3. The information processing apparatus according to supplementary note 1 or 2, wherein
the relationship estimation unit estimates whether the activity area is a birthplace of a user of the account, based on a comparison result between a feature of a language used by the user of the account and a feature of a language used in the activity area.

4. The information processing apparatus according to any of supplementary notes 1 to 3, wherein
the public information includes information indicating a connection between accounts on the social media, and
the relationship estimation unit estimates a relationship between a user of the account and the activity area, based on the public information being published on the Internet in association with a user of another account having a predetermined relationship with the user of the account.

5. The information processing apparatus according to supplementary note 4, wherein
the relationship estimation unit estimates that the activity area coinciding with a birthplace of a user of the another account is a birthplace of a user of the account.

6. The information processing apparatus according to supplementary note 4 or 5, wherein
the relationship estimation unit
   determines a user of the another account related to the activity area, and
   estimates a relationship between a user of the account and the activity area, based on the public information being published on the Internet in association with the determined another account.

7. The information processing apparatus according to supplementary note 6, wherein
the relationship estimation unit
   estimates a hobby and a preference of a user of the determined another account, based on the public information being published on the Internet in association with the determined another account, and
   estimates a relationship between a user of the account and the activity area, based on a degree of variations in a hobby and a preference of users of a plurality of the determined another accounts.

8. The information processing apparatus according to supplementary note 7, wherein
the relationship estimation unit
   estimates that the activity area is a birthplace of a user of the account when a hobby and a preference of users of a plurality of the determined another accounts vary at a reference level or more, and
   estimates that the activity area is not a birthplace of a user of the account when a hobby and a preference of users of a plurality of the determined another accounts do not vary at a reference level or more.

9. An information processing method including, executing by a computer:
an activity area estimation step of estimating an activity area of a user of
an account of social media, based on public information being published on the Internet in association with the account; and
a relationship estimation step of estimating a relationship between a user of the account and the activity area, based on the public information.

10. A program causing a computer to function as:
an activity area estimation unit that estimates an activity area of a user of an account of social media, based on public information being published on the Internet in association with the account; and
a relationship estimation unit that estimates a relationship between a user of the account and the activity area, based on the public information.

### REFERENCE SIGNS LIST

10 Estimation apparatus
11 First position distribution generation unit
12 Second position distribution generation unit
13 Estimation unit
100 Activity area estimation apparatus
101 Post information acquisition unit
102 Post distribution generation unit
103 Friend information acquisition unit
104 Friend distribution generation unit
105 Activity area estimation unit
106 Activity area output unit
107 Post information filter unit
108 Friend information filter unit
109 Weighting unit
110 Off-line friend discrimination unit
200 Social media system
1000 Information processing apparatus
1001 Activity area estimation unit
1002 Relationship estimation unit
1A Processor
2A Memory
3A Input/output I/F
4A Peripheral circuit
5A Bus

What is claimed is:

1. An information processing apparatus comprising:
at least one memory configured to store one or more instructions; and
at least one processor configured to execute the one or more instructions to:
estimate an activity area of a user of an account of social media, based on public information being published on the Internet in association with the account; and
estimate a relationship between a user of the account and the activity area, based on the public information.

2. The information processing apparatus according to claim 1, wherein
the public information includes a post material being posted on the Internet by a user of the account, and
the at least one processor is further configured to execute the one or more instructions to
estimate a post place of the post material, and
estimate a period in which a user of the account is active in the activity area, based on a post period of the post material in which the post place is included in the activity area.

3. The information processing apparatus according to claim 1, wherein
the at least one processor is further configured to execute the one or more instructions to estimate whether the activity area is a birthplace of a user of the account, based on a comparison result between a feature of a language used by the user of the account and a feature of a language used in the activity area.

4. The information processing apparatus according to claim 1, wherein
the public information includes information indicating a connection between accounts on the social media, and
the at least one processor is further configured to execute the one or more instructions to estimate a relationship between a user of the account and the activity area, based on the public information being published on the Internet in association with a user of another account having a predetermined relationship with the user of the account.

5. The information processing apparatus according to claim 4, wherein
the at least one processor is further configured to execute the one or more instructions to estimate that the activity area coinciding with a birthplace of a user of the another account is a birthplace of a user of the account.

6. The information processing apparatus according to claim 4, wherein
the at least one processor is further configured to execute the one or more instructions to
determine a user of the another account related to the activity area, and
estimate a relationship between a user of the account and the activity area, based on the public information being published on the Internet in association with the determined another account.

7. The information processing apparatus according to claim 6, wherein
the at least one processor is further configured to execute the one or more instructions to
estimate a hobby and a preference of a user of the determined another account, based on the public information being published on the Internet in association with the determined another account, and
estimate a relationship between a user of the account and the activity area, based on a degree of variations in a hobby and a preference of users of a plurality of the determined another accounts.

8. The information processing apparatus according to claim 7, wherein
the at least one processor is further configured to execute the one or more instructions to
estimate that the activity area is a birthplace of a user of the account when a hobby and a preference of users of a plurality of the determined another accounts vary at a reference level or more, and
estimate that the activity area is not a birthplace of a user of the account when a hobby and a preference of users of a plurality of the determined another accounts do not vary at a reference level or more.

9. An information processing method comprising,
executing by a computer:
estimating an activity area of a user of an account of social media, based on public information being published on the Internet in association with the account; and
estimating a relationship between a user of the account and the activity area, based on the public information.

10. A non-transitory storage medium storing a program causing a computer to
estimate an activity area of a user of an account of social media, based on public information being published on the Internet in association with the account; and
estimate a relationship between a user of the account and the activity area, based on the public information.

11. The information processing method according to claim 9, wherein
the public information includes a post material being posted on the Internet by a user of the account, and
the computer
estimates a post place of the post material, and
estimates a period in which a user of the account is active in the activity area, based on a post period of the post material in which the post place is included in the activity area.

12. The information processing method according to claim 9, wherein
the computer estimates whether the activity area is a birthplace of a user of the account, based on a comparison result between a feature of a language used by the user of the account and a feature of a language used in the activity area.

13. The information processing method according to claim 9, wherein
the public information includes information indicating a connection between accounts on the social media, and
the computer estimates a relationship between a user of the account and the activity area, based on the public information being published on the Internet in association with a user of another account having a predetermined relationship with the user of the account.

14. The information processing method according to claim 13, wherein
the computer estimates that the activity area coinciding with a birthplace of a user of the another account is a birthplace of a user of the account.

15. The information processing method according to claim 13, wherein
the computer
determines a user of the another account related to the activity area, and
estimates a relationship between a user of the account and the activity area, based on the public information being published on the Internet in association with the determined another account.

16. The non-transitory storage medium according to claim 10, wherein
the public information includes a post material being posted on the Internet by a user of the account, and
the program causing the computer to
estimate a post place of the post material, and
estimate a period in which a user of the account is active in the activity area, based on a post period of the post material in which the post place is included in the activity area.

17. The non-transitory storage medium according to claim 10, wherein
the program causing the computer to estimate whether the activity area is a birthplace of a user of the account, based on a comparison result between a feature of a language used by the user of the account and a feature of a language used in the activity area.

18. The non-transitory storage medium according to claim 10, wherein
the public information includes information indicating a connection between accounts on the social media, and
the program causing the computer to estimate a relationship between a user of the account and the activity area, based on the public information being published on the Internet in association with a user of another account having a predetermined relationship with the user of the account.

19. The non-transitory storage medium according to claim 18, wherein
the program causing the computer to estimate that the activity area coinciding with a birthplace of a user of the another account is a birthplace of a user of the account.

20. The non-transitory storage medium according to claim 18, wherein
the program causing the computer to
determine a user of the another account related to the activity area, and
estimate a relationship between a user of the account and the activity area, based on the public information being published on the Internet in association with the determined another account.
